(19) United States
(12) Patent Application Publication
(10) Pub. No.: US 2015/0319225 A1
(43) Pub. Date: Nov. 5, 2015

(54) PROCESSOR, COMMUNICATION DEVICE, COMMUNICATION SYSTEM, COMMUNICATION METHOD AND NON-TRANSITORY COMPUTER READABLE MEDIUM

(71) Applicant: KABUSHIKI KAISHA TOSHIBA, Tokyo (JP)

(72) Inventors: Takahiro YAMAURA, Kawasaki (JP); Yuta KOBAYASHI, Kawasaki (JP)

(21) Appl. No.: 14/696,654

(22) Filed: Apr. 27, 2015

(30) Foreign Application Priority Data
Apr. 30, 2014 (JP) 2014-094116

(51) Int. Cl. H04L 29/08; H04L 29/06; H04L 12/26

(52) U.S. Cl. CPC H04L 67/10; H04L 43/10; H04L 65/60

(57) ABSTRACT

According to one embodiment, a processor for a communication device including a plurality of communicators connected to a network, includes a manager and a selector. The manager manages states of the communicators in the communication device. The selector selects the communicator from among the communicators on basis of the states of the communicators and socket information generated for a communication terminal with which the communication device communicates through the network. The processor controls the communication device to transmit a frame related to the socket information from the communicator selected by the selector.

### CROSS-REFERENCE TO RELATED APPLICATIONS

This application is based upon and claims the benefit of priority from Japanese Patent Application No. 2014-94116, filed Apr. 30, 2014; the entire contents of which are incorporated herein by reference.

### FIELD

Embodiments described herein relate to a processor, a communication device, a communication system, a communication method and a non-transitory computer readable medium.

### BACKGROUND

In a conventional communication device, a TOE (TCP/IP Offload Engine) that performs a process of a TCP/IP (Transmission Control Protocol/Internet Protocol) not by a CPU (Central Processing Unit) but by exclusive hardware is known. There is a method of combining the plurality of TOEs and realizing improvement of failure resistance, load distribution and a speed of communication. However, in this method, since session information is managed in each TOE, in the case that a frame of a certain session is transmitting in a first TOE, in order to transmit a frame of the same session from a different second TOE, a process of shifting the session information from the first TOE to the second TOE by the CPU is needed. Therefore, the TOEs cannot be switched quickly. Also, in this method, it is needed to provide a MAC (Media Access Controller) for each TOE, and in order to use the plurality of MACs, the TOEs for the same number of the MACs are needed. Therefore, there are problems that a circuit scale becomes big and a cost increases.

### BRIEF DESCRIPTION OF THE DRAWINGS

FIG. 1 is a block diagram illustrating a communication system according to a first embodiment;

FIG. 2 is a diagram illustrating an operation sequence of communication using HTTP;

FIG. 3 is a diagram illustrating detailed configurations of a communication card and a CPU;

FIGS. 4(A) and 4(B) are diagrams describing socket information;

FIGS. 5(A) and 5(B) are diagrams describing a transmission queue and a transmission request;

FIG. 6 is a flowchart of an operation example of a first transmission frame processor;

FIG. 7 is a block diagram of a communication system according to a second embodiment;

FIG. 8 is a diagram illustrating an operation example in the case of performing a round robin mode in a virtual communicator including four communicators;

FIG. 9 is a diagram illustrating an operation example in the case that there is a communicator which cannot perform communication in the case of performing a round robin mode in the virtual communicator including the four communicators;

FIG. 10 is a diagram illustrating an example of operating a certain virtual communicator in the round robin mode and a different virtual communicator in an XOR load distribution mode; and

FIG. 11 is a diagram describing an output destination switching table.

### DETAILED DESCRIPTION

According to one embodiment, a processor for a communication device including a plurality of communicators connected to a network, includes a manager and a selector. The manager manages states of the communicators in the communication device. The selector selects the communicator from among the communicators on basis of the states of the communicators and socket information generated for a communication terminal with which the communication device communicates through the network. The processor controls the communication device to transmit a frame related to the socket information from the communicator selected by the selector.

Hereinafter, embodiments of the present invention will be described with reference to drawings.

### First Embodiment

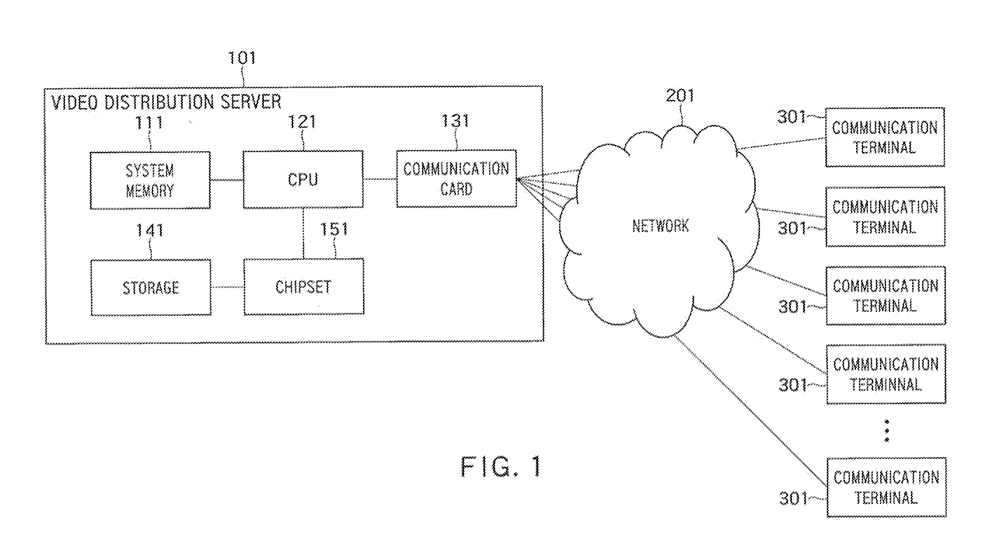

FIG. 1 is a block diagram illustrating a communication system according to a first embodiment of the present invention.

A communication system of the present embodiment is a video distribution server 101 that distributes video images to communication terminal (or viewing terminals) 301. The video distribution server 101 and each communication terminal 301 perform communication using a TCP (Transmission Control Protocol/Internet Protocol). The video distribution server 101 receives a connection request of the TCP from each communication terminal 301 and establishes a TCP connection. Via the established TCP connection, the video distribution server 101 receives a request of video contents by an HTTP from each communication terminal 301, and distributes the video contents. The communication terminal 301 receives the contents transmitted from the video distribution server 101 and displays the video image on a screen.

The video distribution server 101 includes a system memory 111, a CPU 121 (Central Processing Unit), a chipset 151, a storage 141, and a communication card 131, and they are connected to a bus.

The CPU 121 is one form of a processor, reads a program stored in the storage 141 to a memory, and executes it. The CPU 121 is connected with the communication card 131 by the bus. The communication card 131 is one form of a communication device, and is a card loaded with a TOE (TCP/IP Offload Engine) function. As one example, a card (PCI Express card) connected by a PCI Express bus can be used.

The communication card 131 is loaded with an FPGA (Field Programmable Gate Array), a memory, a connector to be connected with the CPU 121, and a plurality of connectors connected with a network 201. For the connector with the network 201, as one example, an SFP+ connector can be used. By performing a TCP/IP process by the FPGA instead of the CPU 121, the card communication card 131 offloads processing loads of the CPU 121 and performs high-speed and power-saving communication.

Also, other than a form of being directly connected with the CPU 121 as illustrated in FIG. 1, the communication card 131 may be connected to the CPU 121 through the chipset 151. Also, while the CPU 121 is connected to the storage 141 through the chipset 151 in the figure, a form of directly connecting the storage 141 to the communication card 131 is also possible. In this case, since the storage 141 can be directly accessed from the communication card 131 without interposing the CPU 121, high-speed data transmission and reception become possible.

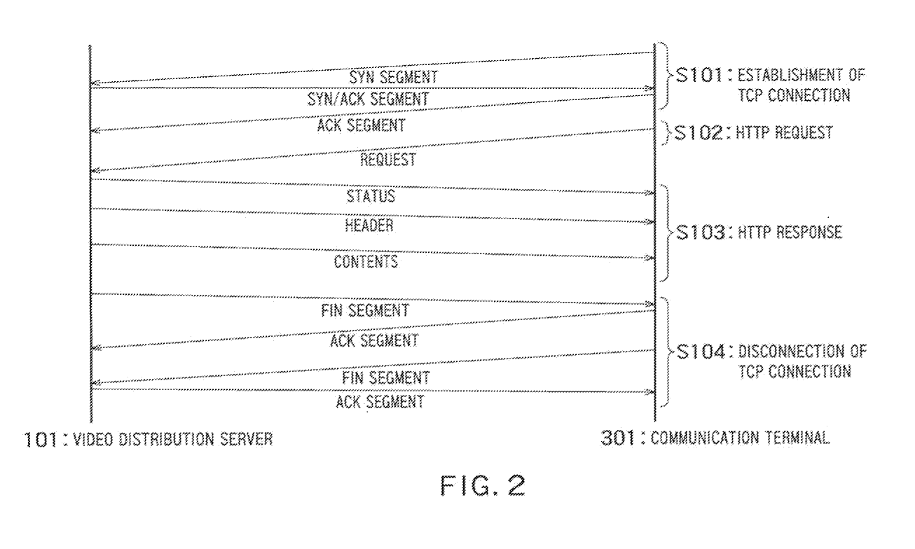

FIG. 2 illustrates an operation sequence of communication using the HTTP. First, in order to establish the TCP connection, the communication terminal 301 transmits an SYN segment for which an SYN bit is 1 in a flag field of a TCP header, and requests the establishment of the connection. The video distribution server 101 which receives it sets a value for which 1 is added to a sequence number of the SYN segment sent from the communication terminal 301 as an acknowledgement number, and transmits an SYN/ACK segment which is a segment for which the SYN bit and an ACK bit in the flag field are 1. Then, the communication terminal 301 sets a value for which 1 is added to a sequence number of the SYN/ACK segment transmitted by the video distribution server 101 as an acknowledgement number, and transmits an ACK segment for which the ACK bit in the flag field is 1. Thus, the TCP connection is established (S101).

Thereafter, the communication terminal 301 uses the established TCP connection and requests the video contents using a GET request of the HTTP (S102), and the video distribution server 101 transmits a status, a header and contents as its response (S103).

When transmission is ended, an FIN segment for which an FIN bit in the flag field of the TCP is turned to 1 is transmitted, and after the ACK segment and the FIN segment are received from the communication terminal 301, the ACK segment for which 1 is added to a sequence number of the FIN segment is transmitted. Thus, the TCP connection is disconnected (S104). When HTTP1.1 is used, within one TCP connection, the request (S102) and the response (S103) of the HTTP can be repeated until respective upper limit numbers of times are reached.

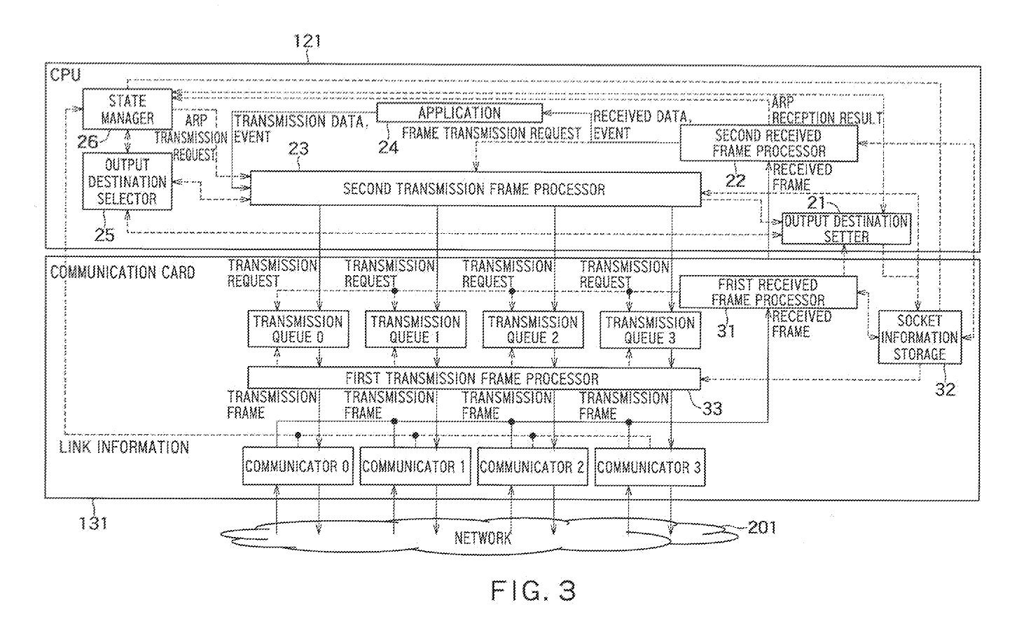

FIG. 3 illustrates detailed configurations of the communication card 131 and the CPU 121. Dotted lines in the figure illustrate flow of control, and solid lines illustrate flow of data. Also, black dots in the figure illustrate that a signal line of the control or the data is connected.

The communication card 131 includes a plurality of communicators 0, 1, 2 and 3, a first received frame processor 31, a plurality of transmission queues 0, 1, 2 and 3, a first transmission frame processor 33, and a socket information storage 32. Each communicator is connected to the network 201, and transmits a frame to the network 201 and receives a frame from the network 201. The first received frame processor 31 processes a protocol of the frame received in each communicator. The plurality of transmission queues store transmission requests to the individual communicators. The first transmission frame processor 33 reads the transmission request from the transmission queue, generates the frame according to the transmission request by a protocol process, and transmits the frame from the communicator corresponding to the transmission queue. The socket information storage 32 is a storage device that stores socket information related to the TCP connection.

As one example, the socket information storage 32 and the transmission queues 0-3 are realized by the memory on the communication card 131, and the communicators 0-3, the first transmission frame processor 33 and the first received frame processor 31 are realized by the FPGA. The socket information storage 32 may be provided in the system memory 111 or may be provided inside the CPU 121, other than being provided in the communication card.

The CPU 121 achieves a second received frame processor 22, a second transmission frame processor 23, a state manager 26, an output destination selector 25, and an output destination setter 21. Also, the CPU 121 achieves an executor 24 that executes an application. The second received frame processor 22 processes a protocol of a frame delivered from the communication card. The second transmission frame processor 23 processes a protocol of a frame to be transmitted. The state manager 26 manages a state of each communicator such as whether or not each communicator is in a communicable state (presence/absence of an operation) and a load state of each communicator. The output destination selector 25 selects the communicator to transmit the frame on the basis of the state of each communicator or the like. The output destination setter 21 sets identification information (called an output communicator identifier, hereinafter) of the communicator selected in the output destination selector 25 to relevant socket information in the socket information storage 32. The socket information includes the identification information (output communicator identifier) of the communicator to transmit the frame related to the corresponding socket information. The CPU 121 utilizes these processors to perform control so that the frame is transmitted from the communication card by the communicator selected in the output destination selector 25.

The communicators 0-3 are connected with a wired or wireless communication network 201. An example of a wired network is an Ethernet (registered trademark) or the like and examples of a wireless network are a wireless LAN network of an IEEE standard and a cellular network of a cellular phone or the like. While the communicators 0-3 are connected to the same network in the figure, a part of the communicators 0-3 may be connected to respectively different networks. For instance, they may be connected to networks of different network addresses (for instance, respectively different Ethernets) like the communicators 0 and 1 being connected to the same network and the communicators 2 and 3 being connected to the same network. The communicators 0-3 may include a counter that calculates an amount of data (such as the number of bytes) transmitted, received or transmitted and received in the relevant communicator.

The communicators 0-3 execute functions corresponding to a physical layer and a data link layer of an OSI (Open Systems Interconnection) reference model. As one example, the communicators 0-3 execute a MAC (Media Access Control) function and a PHY (Physical Layer) function mounted on the FPGA. The communicators 0-3 perform a PHY process and a MAC process to signals received from the network 201, acquire a frame (MAC frame), and output the frame to the first received frame processor 31 connected by the bus. Also, the frame inputted from the first transmission frame processor 33 is outputted to the network 201.

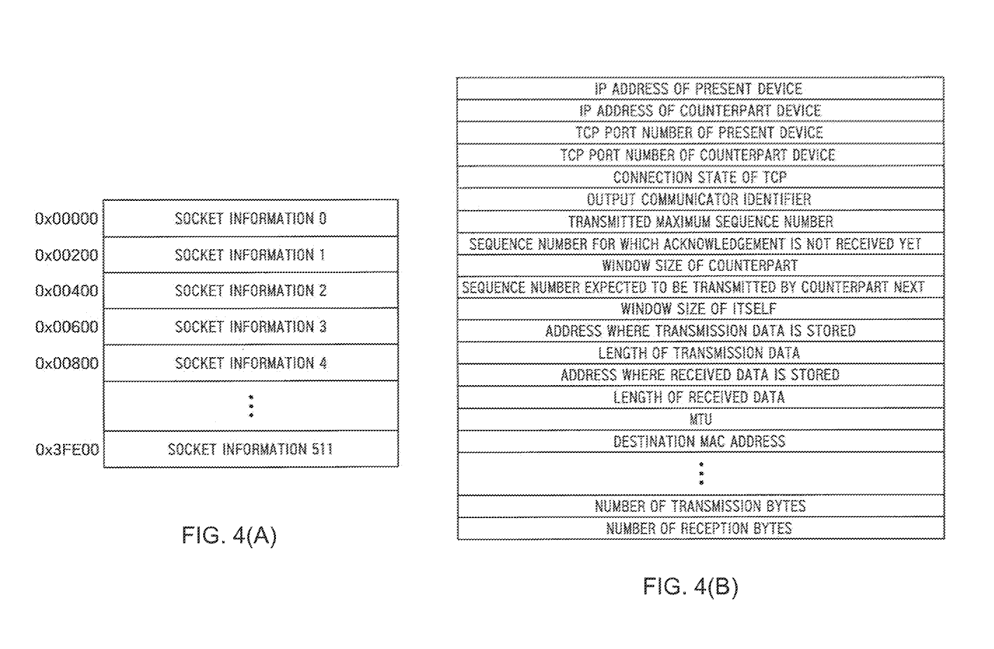

The socket information storage 32 stores the socket information related to the TCP connection. A socket is an interface for performing the communication, and the socket information includes information needed for performing the communication by individual communication protocols. The information stored in the socket information is different depending on the individual communication protocols, and for example, in the socket information of the TCP, as illustrated in FIG. 4(B), an IP address of a present device, an IP address of a counterpart device, a port number of the present device, and a port number of the counterpart device are stored, and the socket or a connection based on the socket can be identified by the set. In a connectionless protocol, the socket may be identified using the IP address of the present device and the port number of the present device or the like for example. Also, the information, such as a TCP connection state, the output communicator identifier, the maximum sequence number transmitted by then, a sequence number for which acknowledgement is not received yet, a window size of a counterpart, a sequence number expected to be transmitted by the counterpart next (for example, the minimum value of the sequence numbers already received by then +1), a window size of itself (reception window size), an address where transmission data to be transmitted to the counterpart is stored, a length of the transmission data, an MTU (Maximum Transmission Unit), a destination MAC address, the number of transmission bytes (the total number of bytes of the data transmitted in association with the socket information by then) and the number of reception bytes (the total number of bytes of received data in association with the socket information by then), is stored for each socket. In the present embodiment, one of features is that the output communicator identifier (the identification information of the communicator) is included in the socket information in particular. The socket information storage 32 can, as illustrated in FIG. 4(A), store the socket information of each socket as long as a capacity of the memory allows, and an address can be imparted to each socket information.

The first received frame processor 31 performs a process of the protocol of each layer to the frame (MAC frame) inputted from the communicator. For example, the first received frame processor 31 is capable of performing the processes of an Ethernet protocol, IPv4, and the TCP. Specifically, the first received frame processor 31 takes out a number of a upper layer protocol from a type value of an Ethernet header of the received frame, and performs version check and checksum verification of the IPv4, flag check and checksum verification of the TCP, verification of the sequence number, verification of the acknowledgement number, acquisition of the window size, instructing of transmission of the acknowledge segment (ACK segment), and write of received data, etc.

In the case that the received frame is other than the above-described protocols (IPv4, TCP), the first received frame processor 31 delivers the received frame to the second received frame processor 22 operated in the CPU 121. However, it is not that the first received frame processor 31 can perform all the processes of the protocols (IPv4, TCP), and delivers the received frame to the second received frame processor 22 operated by software on the CPU 121 in the case of receiving a TCP segment for which a SYN flag of a FIN flag in the flag field of the TCP is 1 as well. In the other cases, the received frame is not delivered to the second received frame processor 22 and is processed within the communication card 131. In the case that the SYN flag of the received TCP segment is 1 and an ACK flag is 0 (that is, in the case that the received TCP segment is a connection establishment request), the first received frame processor 31 generates (secures) the socket information inside the socket information storage 32. Also, in the case of transmitting the TCP segment for which the SYN flag is 1 and the ACK flag is 0 (in the case of transmitting the connection establishment request from the server), the socket information is generated (secured) inside the socket information storage 32.

In the case that a connection state is a SYN_SENT state and the segment for which the SYN flag and the ACK flag are 1 is received (that is, in the case that the ACK segment to the connection establishment request transmitted by the server is received), the first received frame processor 31 checks the sequence number and the acknowledgement number, shifts the connection state of the socket information to an ESTABLISHED state, and thus establishes the connection. Also, the socket information is specified by searching the matching socket information from the socket information storage 32 using the IP address and port number of the received frame. Similarly, in the case that the connection state is a SYN_RECEIVED state and the segment for which the SYN flag is 0 and the ACK flag is 1 is received (that is, in the case that the segment for which the SYN flag and the ACK flag are 1 is returned for the connection establishment request received from the communication terminal 301 and the ACK segment for it is received), the sequence number and the acknowledgement number are checked, the connection state is shifted to the ESTABLISHED state, and the connection is established.

In the case of receiving the TCP segment including data after the connection is established, the first received frame processor 31 reads an address (“an address to store received data” in the socket information) for storing received data (a payload portion of the TCP segment) from the relevant socket information inside the socket information storage 32, and writes the data to the address. Also, the first received frame processor 31 has a counter for counting the number of data bytes which is an amount of the data of the received TCP segment, and also has a function of storing a value counted in the counter in the socket information.

Also, the first received frame processor 31 gives an instruction to transmit an acknowledgement (ACK) segment for the TCP segment received after the connection is established. The ACK segment is transmitted by putting a transmission request into the transmission queue corresponding to one of the individual communicators. At the time, “ACK” is designated for a type of the transmission request (details of the transmission request will be described later), and the acknowledgement number to be transmitted and the window size to be transmitted are also designated within the transmission request. The acknowledgement number to be transmitted and the window size to be transmitted are specified from the relevant socket information and the header of the received TCP segment. Also, the queue to add the transmission request is the transmission queue corresponding to the communicator indicated by the output communicator identifier within the relevant socket information.

The second received frame processor 22 processes the frame transferred from the first received frame processor 31. As one example, in the second received frame processor 22, the processes of ARP, IPv6 and UDP, etc., are performed. Also, the segment for which the SYN flag or the FIN flag of the TCP is 1 is processed.

Here, the first received frame processor 31 uses a descriptor when transmitting the received frame to the second received frame processor 22. The received frame and the information related to it may be transmitted by arranging an area where the plurality of descriptors including a ring buffer or the like for instance can be stored on the system memory 111 or the other memory, having the first received frame processor 31 write the information such as the address of the corresponding socket information (see FIG. 4(A)) in addition to the information (for instance, the address where the received frame is stored or the like) of the received frame to the descriptor for each frame, and having the second received frame processor 22 read it. In this way, by using the socket information, the first received frame processor 31 and the second received frame processor 22 are operated in cooperation.

The state manager 26 manages the state of each communicator such as whether each communicator is communicable. When there is a change in the state of the communicator, the state manager 26 notifies it to the output destination setter 21. There are mainly two methods of discriminating whether each communicator is communicable. They are a method of monitoring link information of the PHY of each communicator and a method of transmitting a packet such as an ARP (Address Resolution Protocol) packet and monitoring the response.

The link information is monitored by accessing a register interface of each communicator through the bus, and confirming a value of a register. On the basis of the value of the register, whether or not linking-up is performed is monitored, and the state of each communicator is recognized. For the value of the register, a value transmitted from the PHY to the MAC by an MII (Media Independent Interface) or the like is reflected.

Monitoring by the ARP packet is performed by instructing the second transmission frame processor 23 to transmit the ARP packet using the designated communicator. By receiving the ARP packet to be the response in the second received frame processor 22 and notifying the state manager 26 that there is the response, it is recognized that the communicator which has performed transmission is communicable. In the case that there is no response of the ARP packet, by notifying that there is no response to the state manager 26, it is recognized that the communicator is not communicable. The transmission of the ARP packet is an example and a packet of an ICMP (Internet Control Message Protocol) protocol such as a PING packet may be transmitted.

The output destination selector 25 has a function of handling the plurality of communicators virtually as one communicator. For example, the communicator 0, the communicator 1, the communicator 2, and the communicator 3 can be handled as one virtual communicator 0, or the communicator 0 and the communicator 1 can be handled as the virtual communicator 0 and the communicator 2 and the communicator 3 can be handled as a virtual communicator 1. On Linux (registered trademark) or the like, handling the plurality of communicators as one virtual communicator is called bonding, and the virtual communicator is called a bonding device. A configuration of bonding a part of the plurality of communicators and not bonding the rest is also possible. For example, it is possible to bond the communicator 0 and the communicator 1 to attain one virtual communicator 0 and not to bond the communicator 2 and the communicator 3. The communicator configuring the virtual communicator is called a slave. The IP address can be assigned to the virtual communicator and the communicator (not to be bonded). The IP address cannot be assigned to each slave and the IP address assigned to the virtual communicator is applied.

To each virtual communicator, a mode can be individually set. As kinds of the modes, for example, there are a failover mode, an XOR load distribution mode, a transmission load distribution mode, and a transmission/reception load distribution mode.

The failover mode is a mode of determining one communicator (slave) to preferentially perform the transmission among the communicators within the virtual communicator, and switching to another communicator (another slave) when it is detected that the communicator is incommunicable.

The XOR load distribution mode is a mode of determining the communicator to perform the transmission in the virtual communicator using a remainder in the case of dividing an exclusive OR of the MAC addresses, the IP addresses and the port numbers of a transmission source and a destination by the number of the communicators. For example, it is assumed that there are four communicators within the virtual communicator. The XOR of each bit string of the MAC addresses, the IP addresses and the port numbers of the transmission source and the destination is calculated. The value of the obtained XOR is divided by 4 which is the number of the communicators, and the communicator corresponding to the remainder is used. Here, the MAC addresses, the IP addresses and the port numbers of the transmission source and the destination are used, however, various modifications such as using only the IP address and the port number are possible. Also, for bits to be operation targets, 2 bits at an arbitrary part or the like may be utilized without using all the bits. Also, after the communicator is selected, in the case that a link of the communicator is disconnected, the communicator of the next value may be used.

The transmission load distribution mode is a mode of switching the communicator to perform the transmission according to transmission loads of the individual communicators within the virtual communicator. For example, the total of amounts of the data transmitted in the individual communicators is acquired from the counters of the individual communicators, and the communicator may be switched so as to suppress a difference or dispersion of the total amounts of the data transmitted in the individual communicators (that is, to distribute the loads of the transmission and reception). Or, the number of transmission bytes included in the socket information is utilized to calculate the total of the amounts of the data transmitted in the individual communicators, and the communicator may be switched so as to suppress the difference or dispersion of the total amounts of the data transmitted in the individual communicators.

The transmission/reception load distribution mode is a mode of switching the communicator to perform the transmission according to the loads of the transmission and reception of the individual communicators within the virtual communicator. For example, the total of the amounts of the data transmitted and received in the individual communicators is acquired from the counters of the individual communicators, and the communicator may be switched so as to suppress the difference or dispersion of the total amounts of the data transmitted and received in the individual communicators (that is, to distribute the loads of the transmission and reception). Or, the total of the number of the transmission bytes and the number of reception bytes included in the socket information is utilized to calculate the total of the amounts of the data transmitted in the individual communicators, and the communicator may be switched so as to suppress the difference or dispersion of the total amounts of the data transmitted in the individual communicators.

A mode other than the four modes described here may be set. The mode can be set or changed by a manager of the device using an exclusive utility not shown in the figure.

The output destination setter 21 notifies the virtual communicator determined as an output destination of the frame by the first transmission frame processor 33 from the socket information inside the socket information storage 32 and additional information described below to the output destination selector 25, and inquires from which communicator among the communicators of the virtual communicator the frame related to the socket information is to be transmitted. For the additional information, according to the mode of the virtual communicator, appropriate information is acquired and notified. How the first transmission frame processor 33 determines the output destination of the frame will be described later.

When the mode of the virtual communicator is the XOR load distribution mode, as the additional information, the MAC addresses, the IP addresses, and the port numbers of the transmission source and the destination are notified to the output destination selector 25. Then, the output destination setter 21 receives the identification information of the communicator selected by the output destination selector 25, and sets the identification information of the communicator as the output communicator identifier of the socket information. Also, when the mode of the virtual communicator is the failover mode, since the communicator to be preferentially used is set in the output destination selector beforehand, it is not needed to transmit the additional information.

The output destination setter 21 acquires the identification information of the communicator to be used by inquiring the output destination selector 25 with an instruction from the first received frame processor 31, the second transmission frame processor 23, the state manager 26 and the output destination selector 25 as a trigger, and sets the output communicator identifier to the socket information.

In more detail, in the case that the TCP connection state becomes the ESTABLISHED state, the first received frame processor 31 instructs the output destination setter 21 to set the output communicator identifier to the socket information.

In the case that data transmission is instructed from an application 24, the second transmission frame processor 23 instructs the output destination setter 21 to set the output communicator identifier to the socket information of the socket that transmits the data.

When the change of the state of the communicator (such as the change from being communicable to being incommunicable) is detected, the state manager 26 instructs the output destination setter 21 to reset the output communicator identifiers of all the pieces of the socket information in which the output destination is the relevant communicator, or another communicator belonging to the same virtual communicator as the relevant communicator, or both of them.

When the mode of the virtual communicator is changed or in the case that the communicators configuring the virtual communicator are changed (for example, in the case that the communicators are increased or decreased), the output destination selector 25 instructs the output destination setter 21 to reset the output communicator identifiers of all the pieces of the relevant socket information (for example, all the pieces of the socket information in which the communicator within the relevant virtual communicator is designated as the output destination). Also, in the case that the communicator to be given priority in the failover mode is changed by the manager in the output destination selector 25 or in the case that the time (such as 10 seconds) set beforehand elapses in the transmission load distribution mode and the transmission/reception load distribution mode, similarly, the output destination setter 21 is instructed to reset the output communicator identifiers of all the pieces of the relevant socket information.

The second transmission frame processor 23 performs a process for transmitting the frame by an instruction from the application 24, the second received frame processor 22 or the state manager 26.

For example, from the application 24 to the second transmission frame processor 23, an instruction of an event such as connection establishment is notified. Also, after the connection is established, an instruction of data transmission is notified.

Also, from the second received frame processor 22 to the second transmission frame processor 23, an instruction to transmit an echo response packet of the ICMP is notified in the case that an echo request packet of the ICMP is received in the second received frame processor 22 or the like. Also, in the case that the SYN segment of the TCP is received in the second received frame processor 22, an instruction is notified to transmit the SYN/ACK segment.

Also, from the state manager 26 to the second transmission frame processor 23, an instruction to transmit the ARP packet is notified in order to check the communication state of each communicator.

The second transmission frame processor 23 can access the socket information storage 32. The second transmission frame processor 23 has a function of setting the value of the socket information as needed.

For example, the sequence number, the MTU, an address to store the transmission data, a length of the transmission data, and the like are set.

The second transmission frame processor 23 determines which communicator is to be used for instructed frame transmission, that is, the output destination of the frame. This is an operation generally called routing, and by using which communicator among the plurality of communicators the frame is to be transmitted is determined basically according to a rule described in a table called a routing table.

The plurality of communicators here indicate both of the virtual communicator and the communicator which is not made virtual. For example, when it is assumed that the communicator and the communicator 1 are handled as one virtual communicator 0 and the communicator 2 and the communicator are not made virtual (do not belong to any virtual communicator), the plurality of communicators are the three of the virtual communicator 0, the communicator 2, and the communicator 3.

The routing table is set such that, for example, when there is a communicator belonging to the same network segment as the destination IP address, the communication is performed using the communicator, and when there is no communicator belonging to the same segment, the communication is performed with a default gateway using a predetermined communicator. The default gateway is a gateway used when a route to perform the transmission is unknown.

When it is determined to perform the communication using the virtual communicator as a result of routing, the output destination setter 21 is instructed to inquire the output destination selector 25 and set the output communicator identifier. The output destination setter 21 inquires which communicator (slave) within the virtual communicator is to be used to the output destination selector 25, and sets the identification information of the communicator designated from the output destination selector 25 to the output communicator identifier of the socket information. Or, the second transmission frame processor 23 may inquire the output destination selector 25, acquire the output communicator identifier, and instruct the output destination setter 21 to set the acquired output communicator identifier to the socket information. In the case of using the virtual communicator, the communicator to perform output is determined using the output destination selector 25 in this way.

When inquiring the output destination selector 25, the second transmission frame processor 23 or the output destination setter 21 notifies the identification information of the virtual communicator and the information needed according to the mode of the virtual communicator to the output destination selector 25. Examples of the needed information are all or a part of the MAC addresses of the transmission source and the destination, the IP addresses of the transmission source and the destination, and the TCP port numbers of the transmission source and the destination or the like.

On the other hand, when it is determined to perform the communication using the communicator which is not the virtual communicator as a result of routing, the second transmission frame processor 23 determines the communicator as the communicator to perform the output.

The second transmission frame processor 23 adds a transmission request of the frame to the transmission queue corresponding to the communicator determined in this way (the communicator obtained by inquiring the output destination selector 25 when it is determined to perform the communication using the virtual communicator, and that communicator when it is determined to perform the communication using the communicator which is not the virtual communicator).

The transmission queues 0-3 correspond to the communicators 1-3, respectively. The transmission queues 0-3 receive the transmission request from the first received frame processor 31, the second transmission frame processor 23, or the first transmission frame processor 33, and hold the received transmission request inside. The transmission queues output the transmission request held inside to the first transmission frame processor 33 in a FIFO (First In First Out) manner.

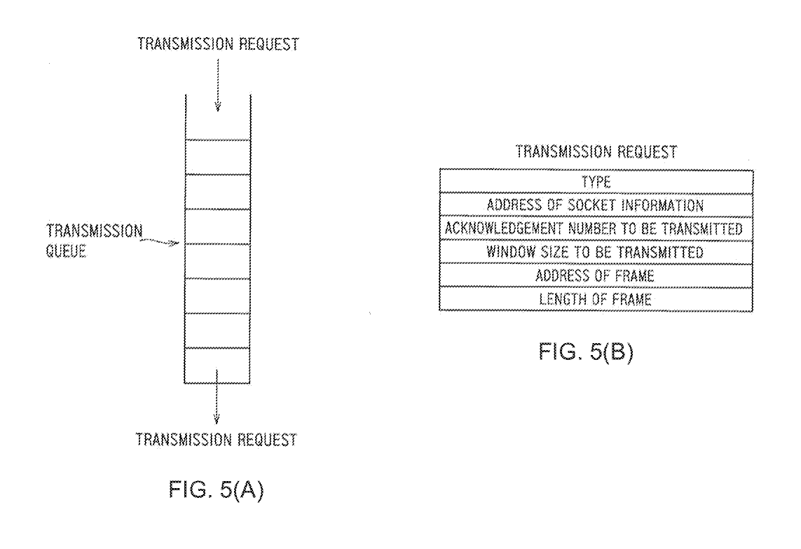

FIG. 5(A) illustrates a configuration of the transmission queue, and FIG. 5(B) illustrates a configuration of the transmission request.

The transmission request includes a type field and the other fields, and the other fields are different according to a value (type value) of the type field. The other fields are the address of the socket information, the acknowledgement number to be transmitted, the window size to be transmitted, the address of the frame, and the length of the frame, and one or the plurality of fields among them are used according to the type value. In the Figure, all the fields are illustrated for convenience.

There are “DATA”, “FRAME”, and “ACK” for the types. “DATA” is a type that instructs the transmission of the data by the TCP segment, “FRAME” is a type that instructs the transmission of the frame generated in the second transmission frame processor 23, and “ACK” is a type that instructs the transmission of the ACK segment. In the case of “DATA” and “ACK”, the frame to be transmitted is generated utilizing the socket information in the first transmission frame processor 33, however, in the case of “FRAME”, the frame is generated utilizing the socket information in the second transmission frame processor 23.

As described above, the field of the transmission request to be used is different for each type value. In the case that the type is DATA, only the address of the socket information is used. In the case that the type is FRAME, only the address of the frame and the length of the frame are used. In the case that the type is ACK, only the address of the socket information, the acknowledgement number to be transmitted and the window size to be transmitted are used.

From the first received frame processor 31, the transmission request of the type being ACK is inputted. At the time, the first received frame processor 31 sets the address of the socket information to transmit the ACK segment (see FIG. 4(A)), the acknowledgement number to be transmitted and the window size to be transmitted to the transmission request. The first received frame processor 31 outputs the transmission request to the transmission queue corresponding to the communicator indicated by the output communicator identifier of the socket information. The first received frame processor 31 generates the transmission request in the case that a process of receiving the data of the TCP is performed or the like.

Also, from the second transmission frame processor 23, the transmission request of the type being FRAME is inputted. At the time, the second transmission frame processor 23 sets the address where the frame to be transmitted is stored and the length of the frame to the transmission request. By the instruction from the application 24, the second received frame processor 22, or the state manager 26, the second transmission frame processor 23 generates the frame of the ARP packet, the ICMP packet, the SYN segment of the TCP, the SYN/ACK segment, or the like, and generates the transmission request of the frame.

Further, from the second transmission frame processor 23, the transmission request of the type being DATA is inputted. At the time, the second transmission frame processor 23 sets the address and length of the transmission data designated from the application to the socket information, instructs the output destination setter 21 to set the output communicator identifier of the socket information further, and then sets the address of the socket information to an address field of the socket information of the transmission request. The second transmission frame processor 23 generates the transmission request of the data designated by the application 24 by the instruction to transmit the data from the application 24.

The first transmission frame processor 33 selects the individual transmission queues in turns in a prescribed order, and takes out the transmission request from the selected transmission queue. Then, the frame according to the type included in the taken-out transmission request is outputted to the communicator corresponding to the transmission queue. The first transmission frame processor 33 repeats selection in the prescribed order from the first when the selection is performed to the last. A cyclic selecting method like this is called a round robin.

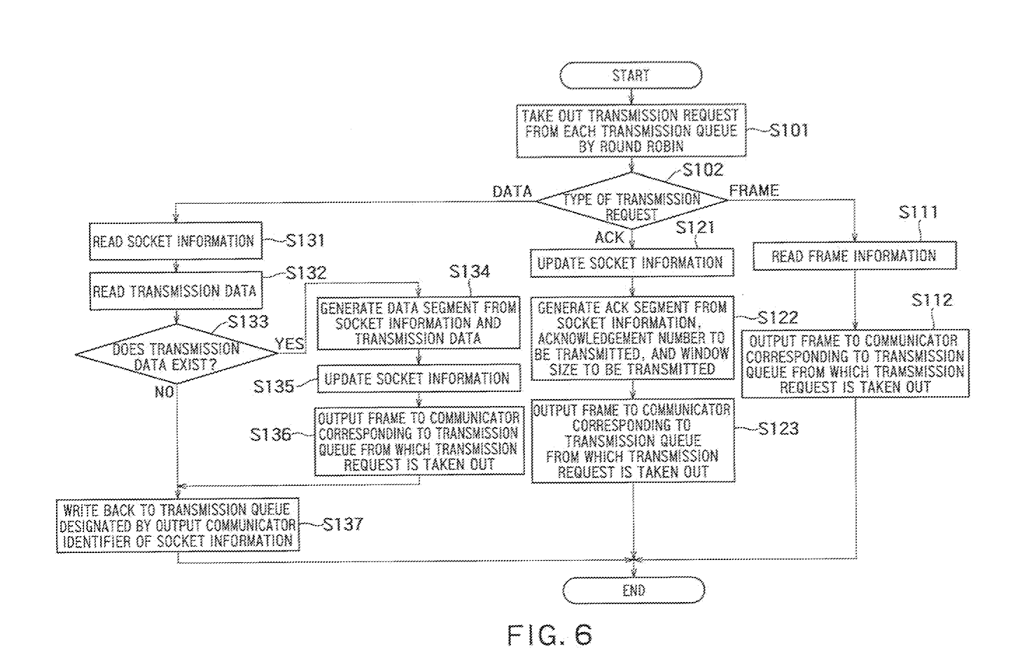

FIG. 6 illustrates a flowchart of an operation example of the first transmission frame processor 33. The first transmission frame processor 33 takes out the transmission request from each transmission queue by the round robin (S101).

In the case that the type of the taken-out transmission request is “DATA”, the first transmission frame processor 33 reads the address of the socket information from the transmission request, and reads the relevant socket information from the socket information storage 32 (S131). The address where the transmission data is stored and the length of the transmission data are set to the socket information, and when the length is not 0, it is determined to transmit the data (S132, YES in S133).

The first transmission frame processor 33 reads the window size of the counterpart, the MTU, a congestion window size (not shown in FIG. 4), and the like from the socket information, calculates transmittable bytes, puts the data for that on a payload, generates the data segment of the TCP, performs processes of header generation of IP and Ethernet protocol and a checksum or the like, and thus generates the frame (S134).

The first transmission frame processor 33 updates the socket information by adding the transmitted maximum sequence number, advancing the address where the transmission data is stored, and subtracting the length of the transmission data or the like for the transmission of the data (S135). The first transmission frame processor 33 also has a function of counting the number of the data bytes which is the amount of the data of the transmitted TCP segment and storing it in the socket information. The first transmission frame processor 33 outputs the generated frame to the communicator corresponding to the transmission queue (5136). The order of an updating step of the socket information and an outputting step of the frame may be reversed or they may be performed in parallel.

When the frame is outputted, the first transmission frame processor 33 generates the transmission request of the type being DATA, for which the same address as the socket information is set to the address field of the socket information. At the time, to the transmission request, the address and length of the transmission data are set on the basis of the socket information updated in step S135. The first transmission frame processor 33 outputs the generated transmission request to the transmission queue corresponding to the communicator indicated by the output communicator identifier of the socket information (S137). The processes of steps S133-S137 are repeated until there is no more transmission data.

By the processes of steps S133-S137, the same transmission queue and communicator are repeatedly used as long as the output communicator identifier is not updated, and the data is transmitted. However, in the case that the output communicator identifier of the socket information is updated in the middle by the output destination setter 21 due to the communicator being incommunicable, mode change of the virtual communicator, or the like, there is a possibility that the transmission queue and the communicator to be used are changed. In this way, even while using the same socket, the communicator to be used can be switched.

On the other hand, in the case that the type of the transmission request taken out in step S101 is “ACK”, the first transmission frame processor 33 reads the address of the socket information, the acknowledgement number to be transmitted, and the window size to be transmitted from the transmission request. The relevant socket information is read from the address of the socket information (S121), the ACK segment of the TCP is generated using the transmitted maximum sequence number included in the read socket information and the acknowledgement number to be transmitted and the window size to be transmitted that are read from the transmission request, and the frame is generated by performing the header generation of the IP and Ethernet protocol and checksum calculation further (S122). The first transmission frame processor 33 outputs the generated frame to the communicator corresponding to the transmission queue from which the transmission request is taken out (S123).

Also, in the case that the type of the transmission request taken out in step S101 is “FRAME”, the first transmission frame processor 33 takes out the address of the frame and the length of the frame as frame information from the transmission request (S111). The frame is read according to the frame information, and the read frame is outputted to the communicator corresponding to the transmission queue from which the transmission request is taken out (S112).

As above, according to the present embodiment, the output communicator identifier of the socket information is set by the output destination setter 21 of the CPU 121, it is referred to, and a first transmission processor and the first received frame processor 31 of the communication card 131 (hardware) determine the transmission queue to output the transmission request. By changing the output communicator identifier of the socket information, the communicator to be used can be easily switched even for the same socket. That is, the processes such as the selection of the communicator to be used (setting of the output communicator identifier) are operated by the software operated on the CPU 121, and the communication card 131 (hardware) is operated to switch the transmission queue to input the transmission request so that the frame is outputted from the communicator selected in the CPU 121. Thus, while suppressing circuit scale increase of the hardware, improvement of failure resistance and improvement of load distribution and a communication speed can be realized.

### Second Embodiment

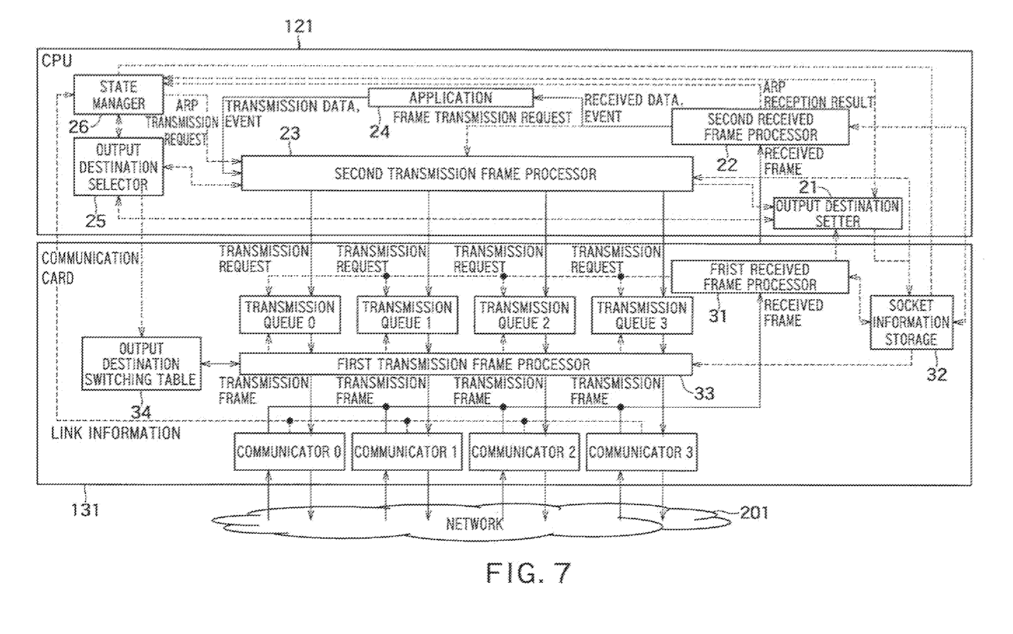

FIG. 7 is a block diagram of a communication system according to a second embodiment.

In the present embodiment, in addition to the first embodiment, an output destination switching table (output destination switching information) 34 that defines a using order of the communicators is provided on the side of the communication card 131. After taking out the transmission request from the transmission queue and processing it, the first transmission frame processor 33 rewrites the output communicator identifier of the socket information according to the output destination switching table 34. To the transmission queue corresponding to the communicator designated by the rewritten output communicator identifier of the socket information, the transmission request for transmitting the next frame to be transmitted by the relevant socket is generated and outputted. Outputting the transmission request of the frame to be transmitted next by the same socket to the transmission queue again in this way is sometimes expressed as writing back the transmission request.

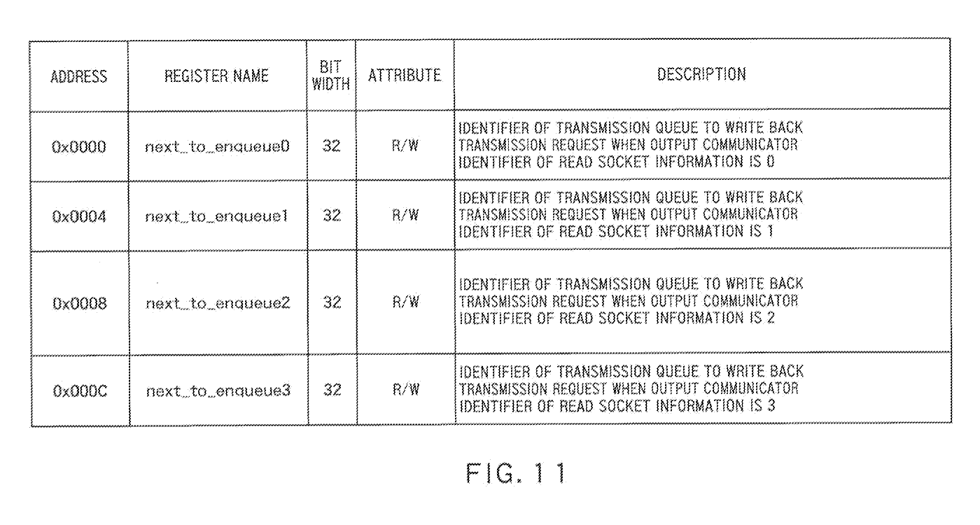

The output destination switching table 34 can be configured as a register realized by the FPGA defined as illustrated in FIG. 11, as one example. The registers for the same number as the number of the communicators exist, an address is set to each register, and a register name illustrated in the figure is imparted respectively. The register can designate the data of a 32-bit width and both of read and write are possible, respectively. Here, four register names that are “next_to_enqueue0”, “next_to_enqueue1”, “next_to_enqueue2”, and “next_to_enqueue3” are indicated.

The register of “next_to_enqueue0” stores an identifier of the transmission queue that is a destination to write back the transmission request (an identifier of the communicator), in the case that the output communicator identifier of the read socket information is 0.

The register of “next_to_enqueue1” stores the identifier of the transmission queue that is the destination to write back the transmission request (the identifier of the communicator), in the case that the output communicator identifier of the read socket information is 1.

The register of “next_to_enqueue2” stores the identifier of the transmission queue that is the destination to write back the transmission request (the identifier of the communicator), in the case that the output communicator identifier of the read socket information is 2.

The register of “next_to_enqueue3” stores the identifier of the transmission queue that is the destination to write back the transmission request (the identifier of the communicator), in the case that the output communicator identifier of the read socket information is 3.

On the basis of the above-described register definitions, an operation in the case of performing a round robin mode in the virtual communicator will be described. The round robin mode is a mode of switching the communicator in turns every time of transmitting the frame among the communicators within the virtual communicator.

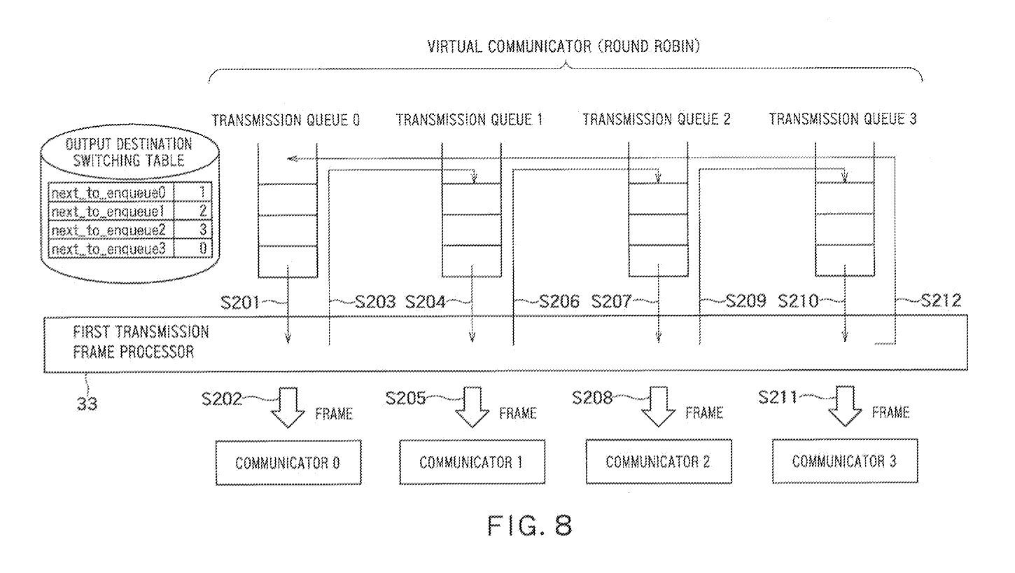

FIG. 8 illustrates an operation example in the case of performing the round robin mode in the virtual communicator including the four communicators that are the communicator 0, the communicator 1, the communicator 2, and the communicator 3. On the left of the figure, examples of values of the individual registers are indicated. By referring to the values of the registers according to the output destination switching table, the communicator (transmission queue) to be used next can be specified. The value of 1 is designated for next_to_enqueue0, the value of 2 is designated for next_to_enqueue1, the value of 3 is designated for next_to_enqueue2, and the value of 0 is designated for next_to_enqueue3. In this case, for example, when paying attention to one certain socket, when the transmission request is stored in the transmission queue 0 first, the communicator to be used is successively switched like the communicator 0, the communicator 1, the communicator 2, the communicator 3, the communicator 0, and the communicator 1 . . . according to the output destination switching table, and the frame including the TCP segment is transmitted.

As the operation of the first transmission frame processor 33 in more detail, the transmission request is taken out from each transmission queue by the round robin, and in the case that the type is “DATA”, the frame including the data segment is outputted to the communicator corresponding to the transmission queue from which taking-out is performed. Thereafter, the sequence number of the socket information, the address and length of the transmission data, and the like are updated, the communicator to be used next is specified according to the output destination switching table 34, and the output communicator identifier of the socket information is rewritten. Then, to the transmission queue corresponding to the communicator indicated by the rewritten output communicator identifier, the transmission request of the type being “DATA” for transmitting the frame next, for which the address of the same socket information is designated to the address field of the socket information, is added. At the time, the address and length of the transmission data in the transmission request are reset on the basis of the updated socket information. In the case that the transmission request of the type being “ACK” is taken out, the frame including the ACK segment is outputted to the communicator corresponding to the transmission queue from which taking-out is performed, then the sequence number of the socket information is updated, and the output communicator identifier of the socket information is rewritten according to the output destination switching table 34. Thus, every time of transmitting the TCP segment, the communicator can be switched to perform the transmission.

As a specific operation example, as illustrated in FIG. 8, in the case that the transmission request of the type being “DATA” is taken out from the transmission queue 0 (S201), the frame is outputted (S202), the output communicator identifier of the socket information is rewritten to 1 according to the output destination switching table 34, then the other fields of the socket information such as the address where the transmission data is stored and the length of the transmission data are updated, and the transmission request of the data frame to be transmitted next of the same socket is added to the transmission queue 1 (S203). The transmission request is to be taken out from the transmission queue 1 later according to the round robin (S204). On the basis of the transmission request, the frame is outputted (S205), the output communicator identifier of the socket information is rewritten to 2 according to the output destination switching table 34, the other fields of the socket information are updated, and the transmission request of the type being “DATA” of the same socket is added to the transmission queue 2 for the transmission of the next frame (S206). At the time, the address and length of the transmission data in the transmission request are reset on the basis of the updated socket information. Thereafter, similarly, the transmission queue and the communicator to be used are successively and cyclically switched (S207, S208, S209, S210, S211, S212).

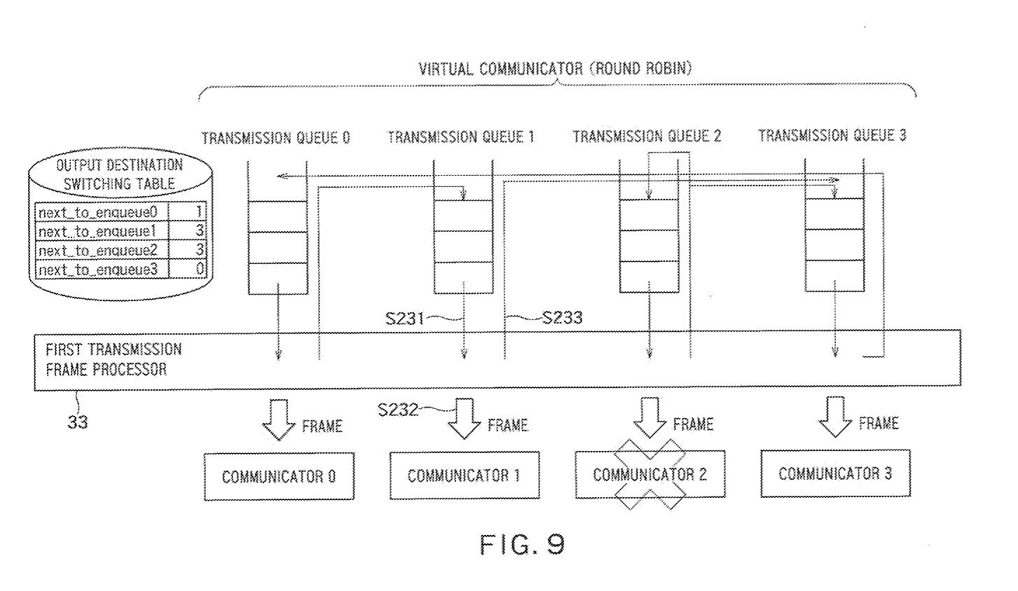

Here, for example, it is assumed that the communicator 2 becomes incommunicable due to link disconnection during the data transmission. In this case, the state manager 26 detects that, and the output destination switching table 34 is updated so as to designate 3 for next_to_enqueue1 by the output destination selector 25. Thereafter, by the output destination setter 21, the output communicator identifier of the socket information is rewritten so as to indicate the communicator other than the communicator 2. When the first transmission frame processor 33 performs the process using the updated output destination switching table 34, it is the operation illustrated in FIG. 9. That is, in the case that the transmission request is taken out from the transmission queue 1 (S231), the frame is outputted on the basis of the transmission request the same as before (S232). Next, the output communicator identifier of the socket information is rewritten to 3 (not 2) according to the output destination switching table 34, the other fields of the socket information are updated, and the transmission request of the data frame to be transmitted next of the same socket is added to the transmission queue 3 (not the transmission queue 2) (S233). By the operation, like the communicator 0, the communicator 1, the communicator 3, and the communicator 0, . . . , the transmission is performed by the round robin excluding the incommunicable communicator 2. In the case that the communicator 2 returns to a communicable state again, the state manager 26 detects that, and next_to_enqueue1 is designated to be 2 by the output destination selector 25. Thus, the transmission can be performed by the round robin using the communicator 2 again.

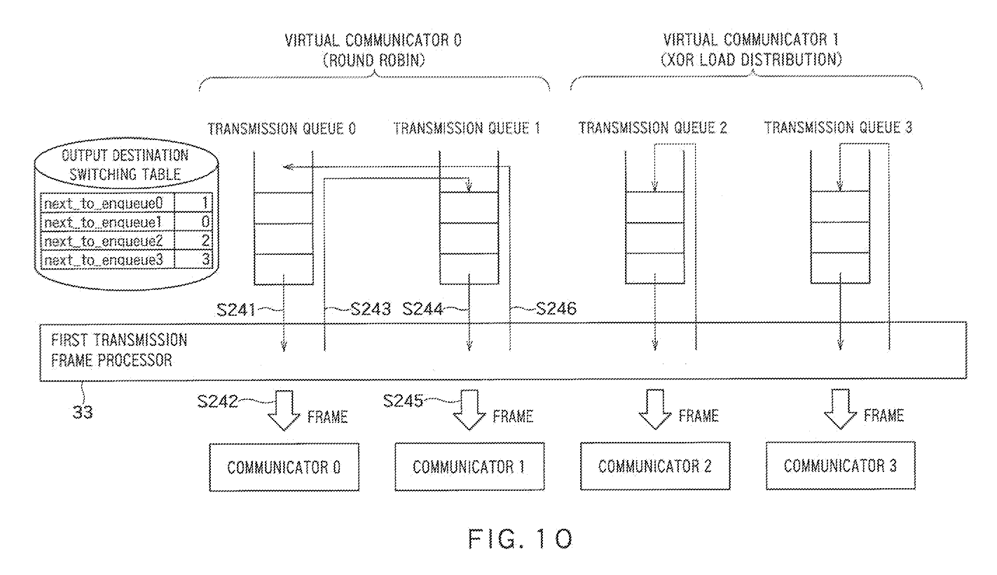

In FIG. 8 and FIG. 9, the case of operating the communicators 0-3 in the round robin mode as one virtual communicator is illustrated. FIG. 10 illustrates an example of operating the communicator 0 and the communicator 1 in the round robin mode as the virtual communicator 0, and the communicator 2 and the communicator 3 in the XOR load distribution mode as the virtual communicator 1.

In this case, as illustrated on the left of FIG. 10, the output destination switching table 34 is set such that next_to_enqueue0 is 1, next_to_enqueue1 is 0, next_to_enqueue2 is 2 and next_to_enqueue3 is 3. While the communicator 0 and the communicator 1 are alternately switched in the communication using the virtual communicator 0, the communicators are not switched in the communication using the virtual communicator 1.

In more detail, in the communication using the virtual communicator 0, the transmission request is taken out from the transmission queue 0 (S241), the frame is transmitted from the communicator 0 (S242), and then the transmission request of the data frame to be transmitted next of the same socket is added to the transmission queue 1 (S243).

Then, the transmission request is taken out from the transmission queue 1 by the round robin (S244), the frame is transmitted from the communicator 1 (S245), and the transmission request of the frame to be transmitted next of the same socket is added to the transmission queue 0 (S246). In this way, like the communicator 0, the communicator 1, the communicator 0, and the communicator the frame can be transmitted while distributing the loads by the round robin. Also, though descriptions are omitted here, the socket information is updated according to the output destination switching table 34 the same as described above in these processes as well.

Also, in the communication using the virtual communicator 1, the transmission request of the frame to be transmitted next of the same socket is written back to the queue set by the output destination setter 21. Thus, the loads can be distributed according to the rule set by the output destination selector 25.

As above, according to the present embodiment, the rule of rewriting the output communicator identifier is set to the output destination switching table 34 in the output destination selector 25, and the output communicator identifier of the relevant socket information is rewritten according to the output destination switching table 34 for each frame transmission in the first transmission frame processor 33. Then, to the transmission queue corresponding to the communicator indicated by the rewritten output communicator identifier, the transmission request of the frame to be transmitted next of the same socket is added. Thus, the round robin mode can be applied to the virtual communicator while suppressing the increase of the mounting circuit scale of the FPGA. Also, the improvement of the failure resistance and the improvement of the load distribution and the communication speed can be realized.

### Modification Example 1

Instead of the FPGA loaded on the communication card 131 in the first and second embodiments, a microprocessor; a DSP (Digital Signal Processor), a GPU (Graphics Processing Unit), or an ASIC (Application Specific Integrated Circuit) may be used. Also, the socket information storage 32 may be provided in the system memory 111 instead of the memory loaded on the communication card 131.

### Modification Example 2

In the first and second embodiments, the individual communicators can use respectively different data link layer protocols. For example, all the communicators may use the Ethernet protocol, or three communicators may use the Ethernet protocol and one communicator may use the protocol of a wireless LAN standard such as IEEE802.11ac.

### Modification Example 3

Also, in the first and second embodiments, an example of storing the number of the transmission bytes and the number of the reception bytes in the socket information in the case of performing the operation in the transmission load distribution mode or the transmission/reception load distribution mode is illustrated. As another example of realizing the transmission load distribution mode or the transmission/reception load distribution mode, the following method is also possible. A hash table for each destination IP address is created using the memory on the communication card 131, and in the second transmission frame processor 23 or the first transmission frame processor 33, the number of the transmission bytes or the number of the reception bytes or both of them are counted for each destination IP address and stored in the hash table. The state manager 26 and the output destination selector 25 may distribute the loads using the information.

### Modification Example 4

Also, in the first and second embodiments, an example of using the TCP is illustrated, however, it is also possible to use a different protocol of UDP or the like. In the UDP, since the connection is not formed and the ACK packet is not transmitted either, the operation can be performed in the round robin mode without using the output communicator identifier of the socket information.

In the case of not using the output communicator identifier of the socket information, the operation is performed using the identifier of the transmission queue instead of the output communicator identifier. First, for example, the transmission request is added to the transmission queue corresponding to the communicator selected by the output destination selector 25 or the communicator that is arbitrarily determined for the virtual communicator determined for certain socket information. The first transmission frame processor 33 takes out the transmission request from each transmission queue, performs the process of the UDP, IP and Ethernet protocol, and outputs the frame to the communicator corresponding to the transmission queue from which taking-out is performed. At the time, in the case that a UDP datagram to be transmitted is divided into a plurality of IP fragment packets and transmitted (such as the case of writing the data larger than the MTU to an UDP socket), the transmission request for transmitting the frame next of the same socket is added to the transmission queue determined according to the output destination switching table 34 (in the case of the second embodiment) (the output communicator identifier of the socket information is not used). In this way, even in the case that the UDP datagram is divided into the plurality of IP fragment packets and transmitted, for each transmission of the IP fragment packet, the communicator can be switched to perform the transmission. In the case of the first embodiment, when transmitting the UDP and changing the communicator to be used, the output destination of the transmission request may be switched to the changed transmission queue before generating the next transmission request.

Also, for example, the address and length of the transmission data in the socket information may be held in an array or a list, and when the transmission request of the UDP datagram is received from the application 24, it may be added to the array or the list, and the first transmission frame processor 33 may perform a transmitting process in order from a leading side for elements of the array or the list (it can be the same in the TCP as well).

### Modification Example 5

In the first and second embodiments, the number of the transmission queues is the same as the number of the communicators, however, the number of the communicators and the number of the transmission queues may be different. For example, the configuration of one transmission queue and four communicators or the like may be adopted, and the output communicator identifier of the socket information may be used to perform control.

### Modification Example 6

Also, in the first and second embodiments, an example that there is one first transmission frame processor 33 is illustrated, however, a configuration may be such that there are two first transmission frame processors 33 for four communicators, and they respectively output the frame to the two different communicators.

### Modification Example 7

In the second embodiment, an example of realizing the output destination switching table by the register of the FPGA is illustrated, however, it may be realized by the system memory 111 or the memory of the communication card. The register, the system memory 111, and the memory of the communication card, are examples of a storage device that stores the output destination switching table (output destination switching information).

The communication device as described above may also be realized using a general-purpose computer device as basic hardware. That is, each block in the communication device can be realized by causing a processor mounted in the above general-purpose computer device to execute a program. In this case, the communication device may be realized by installing the above described program in the computer device beforehand or may be realized by storing the program in a storage medium such as a CD-ROM or distributing the above described program over a network and installing this program in the computer device as appropriate. Furthermore, the storage may also be realized using a memory device or hard disk incorporated in or externally added to the above described computer device or a storage medium such as CD-R, CD-RW, DVD-RAM, DVD-R as appropriate.

Furthermore, the communication device may include a CPU (Central Processing Unit), a ROM (Read Only Memory) and a RAM as one example of circuitry. In this case, each unit or each element in the communication device can be controlled by a CPU's reading out into a RAM and executing a program which is stored in a storage or ROM.

Also, the above-stated hardware configuration is one example and the communication device according to an embodiment can be realized by an integrated circuit such as a LSI (Large Scale Integration) or an IC (Integrated Circuit) chipset as one example of circuitry. Each function block in the data receiving device can be realized by a processor, individually, or a part or all of the function blocks can be integrated and realized by one processor. A means for the integrating the part or all of the function blocks is not limited to the LSI and may be dedicated circuitry or a general-purpose processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A processor for a communication device including a plurality of communicators connected to a network, comprising:
a manager to manage states of the communicators in the communication device; and
a selector to select the communicator from among the communicators on basis of the states of the communicators and socket information generated for a communication terminal with which the communication device communicates through the network;
wherein the processor controls the communication device to transmit a frame related to the socket information from the communicator selected by the selector.

2. The processor according to claim 1, further comprising
a setter to set identification information of the communicator selected by the selector in a first storage accessible by the communication device to be associated with the socket information.

3. The processor according to claim 1,
wherein the selector selects two or more communicators, and
wherein the processor controls that the communication device transmits the frame related to the socket information, using the two or more communicators selected by the selector in an predetermined order.

4. The processor according to claim 3,
wherein the selector sets output destination switching information that specifies the order to use the selected communicators, and stores the output destination switching information in a second storage accessible by the communication device.

5. The processor according to claim 1, comprising
a calculator to calculate amounts of data transmitted or transmitted and received by frames related to the socket information,
wherein the selector selects the communicator so as to distribute loads of transmission or transmission and reception among the communicators, on basis of the amounts of the data calculated by the calculator.

6. The processor according to claim 1,
wherein the manager manages amounts of data transmitted or transmitted and received in the communicators, and
wherein the selector selects the communicator so as to distribute loads of transmission or transmission and reception among the communicators, on the basis of the amounts of the data of the transmission or the transmission and the reception of the communicators managed by the manager.

7. The processor according to claim 1,
wherein the manager monitors presence or absence of an operation of the communicators respectively, and
wherein the selector selects the communicator according to the presence or absence of an operation of the communicators.

8. The processor according to claim 7,
wherein the processor sets the communication device so that the communication device transmits the frame related to the socket information by the communicator selected by the manager.

9. The processor according to claim 7,
wherein the processor sets output destination switching information that specifies an order to use two or more communicators selected by the selector, and stores the output destination switching information in a second storage accessible by the communication device.

10. The processor according to claim 1,
wherein the socket information includes a set of an IP address of the communication device, an IP address of the communication terminal, a port number of the communication device, and a port number of the communication terminal.

11. A communication device that communicates with a communication terminal through a network, comprising:
a plurality of communicators connected to the network; and
a transmission frame processor to transmit a frame related to socket information generated for the communication terminal with use of the communicator selected by a processor, the processor managing states of the communicators and selecting the communicator from among the communicators on basis of the states thereof and the socket information.

12. The communication device according to claim 11,
wherein the transmission frame processor accesses a first storage that stores identification information of the communicator selected by the processor to be associated with the socket information, acquires the identification information of the communicator related to the socket information, and transmits the frame related to the socket information by use of the communicator indicated by an acquired identification information.

13. The communication device according to claim 11,
wherein the communicator is selected according to the presence or absence of an operation of the communicators by the processor which monitors the presence or absence of an operation of the communicators.

14. The communication device according to claim 12,
wherein the communicator is selected according to presence or absence of an operation of the communicators, the processor monitoring the presence or absence of an operation of the communicators, and
wherein the identification information of the communicator stored in the first storage is reset to designate the communicator selected by the processor when the processor selects the communicator.

15. The communication device according to claim 11, comprising
a plurality of transmission queues corresponding to the communicators, and individually storing a transmission request of the frame related to socket information,
wherein the transmission request of the frame related to the socket information is stored in the transmission queue corresponding to the communicator selected by the processor, and
wherein the transmission frame processor transmits the frame related to the socket information according to the transmission request taken out from the transmission queue by use of the communicator corresponding to the transmission queue from which the transmission request is taken out.

16. The communication device according to claim 11, comprising
a plurality of transmission queues corresponding to the plurality of communicators, and individually storing a transmission request of the frame related to socket information,
wherein the transmission request of the frame related to the socket information is stored in the transmission queue corresponding to the communicator selected by the processor, and
wherein the transmission frame processor transmits the frame related to the socket information according to the transmission request taken out from the transmission queue by using the communicator corresponding to the transmission queue from which the transmission request is taken out, and after processing the transmission request, accesses a first storage that stores identification information of the communicator selected by the processor to be associated with the socket information, acquires the identification information of the communicator related to the socket information, and outputs a transmission request of a next frame related to the socket information to the transmission queue corresponding to the communicator indicated by the identification information.

17. The communication device according to claim 11,
wherein the transmission frame processor obtains output destination switching information that specifies an order to use two or more communicators selected by the processor from a second storage that stores the output destination switching information, and transmits the frame related to the socket information by use of the two or more communicators in turns in the order indicated in the output destination switching information.

18. The communication device according to claim 17,
wherein the output destination switching information is set by specifying the order to use the two or more communicators selected by the processor, which monitors communication presence or absence of an operation of the communicators and selects the two or more communicators according to the presence or absence of an operation of the communicators.

19. The communication device according to claim 17, comprising
a plurality of transmission queues corresponding to the communicators, and individually storing a transmission request of the frame related to socket information,
wherein the transmission request of the frame related to the socket information is stored in the transmission queue corresponding to the communicator selected by the processor, and
wherein the transmission frame processor transmits the frame related to the socket information according to the transmission request taken out from the transmission queue by use of the communicator corresponding to the transmission queue from which the transmission request is taken out, and after processing the transmission request, outputs a transmission request of a next frame related to the socket information to the transmission queue corresponding to the communicator determined according to the output destination switching information.

20. The communication device according to claim 19,
wherein a first transmission frame processor, after processing the transmission request, accesses a first storage that stores identification information of the communicator selected by the processor to be associated with the socket information, resets the identification information of the communicator related to the socket information to designate the communicator determined according to the output destination switching information, and outputs the transmission request of the next frame related to the socket information to the transmission queue corresponding to the communicator indicated by the identification information after the reset.

21. The communication device according to claim 12,
wherein the first storage device is provided inside the communication device.

22. The communication device according to claim 17,
wherein the second storage device is provided inside the communication device.

23. The communication device according to claim 11, configured as a communication card.

24. The communication device according to claim 11, wherein the socket information includes a set of an IP address of the communication device, an IP address of the communication terminal, a port number of the communication device, and a port number of the communication terminal.

25. A communication system which communicates with a communication terminal via a network, comprising:
a communication device including a plurality of communicators connected to the network: and
a processor comprising a manager to manage states of the communicators in the communication device and a selector to select the communicator from among the communicators on basis of the states of the communicators and socket information generated for the communication terminal,
wherein the communication device comprises a transmission frame processor which transmit a frame related to the socket information with use of the communicator selected by the processor.

26. A communication method which communicates with a communication terminal via a network, comprising:
managing states of a plurality of communicators in a communication device;
selecting the communicator from among the communicators on basis of the states of the communicators and socket information generated for the communication terminal; and
transmitting a frame related to the socket information with use of the communicator selected.

27. A non-transitory computer readable medium having a program stored therein which cause a computer when executed by the computer to perform processing of steps, comprising:
managing states of a plurality of communicators in a communication device;
selecting the communicator from among the communicators on basis of the states of the communicators socket information generated for the communication terminal; and
transmitting a frame related to the socket information with use of the communicator selected.
